(19) United States
(12) Patent Application Publication
(10) Pub. No.: US 2014/0215011 A1
(43) Pub. Date: Jul. 31, 2014

(54) MESSAGE EXCHANGE VIA GENERIC TLV GENERATOR AND PARSER

(71) Applicant: General Instrument Corporation, Horsham, PA (US)

(72) Inventors: Xiaozhou Fu, San Diego, CA (US); Tat Keung Chen, San Diego, CA (US); Kurtis A. Li, West Covina, CA (US); Fan Wang, San Diego, CA (US)

(73) Assignee: General Instrument Corporation, Horsham, PA (US)

(21) Appl. No.: 14/164,627

(22) Filed: Jan. 27, 2014

Related U.S. Application Data
(60) Provisional application No. 61/756,987, filed on Jan. 25, 2013.

(51) Int. Cl. H04L 29/08

(52) U.S. Cl. CPC H04L 67/02
USPC 709/217

(57) ABSTRACT

A system and methods are provided for processing Type-Length-Value (TLV) Messages with TLV Engines in any TLV-based protocol by using configuration files associated with the protocol. One method provides for generating a TLV message by receiving output from a sender at a message engine, loading one or more configuration files associated with a TLV-based protocol onto the message engine, wherein the configuration files describe information about one more message elements, generating a TLV message at the message engine by creating and ordering the message elements into a TLV message according to the configurations files, and transmitting the TLV message over a network from the message engine.

### CLAIM OF PRIORITY

This application claims priority under 35 U.S.C. §119(e) from earlier filed U.S. Provisional Application Ser. No. 61/756,987, filed Jan. 25, 2013, which is hereby incorporated by reference.

### TECHNICAL FIELD

The present disclosure relates to the field of data transmission particularly data transmission using Type-Length-Value (TLV) message formats.

### BACKGROUND

In networked systems, various hardware and/or software elements can communicate by exchanging data messages. The messages are often sent in a predefined format known to both the sending and receiving elements, such that the receiving element can process and understand the message sent by the sending element. By way of non-limiting examples, TCP/IP protocols use predefined static fields to organize and format messages.

However, the rigid structure of predefined message formats can create incompatibilities when message structures are updated, unless both the sending and receiving elements are made aware of the updated message structure. By way of non-limiting examples, a receiving element that is coded to receive messages according to TCP/IP protocols with predefined static fields would not be able to understand a message that does not use those predefined static fields, includes the fields in a different order, and/or includes extra fields. All elements on the network would need to be updated to send and/or receive messages in a new or updated format. In many cases this can require code to be rewritten and installed on each element on the network before updated message formats can be exchanged, which can be costly and time-consuming.

An alternative to the rigid and inflexible message formats of some traditional systems are Type-Length-Value (TLV) messages. TLV messages have a flexible format because they comprise a plurality of individual TLV elements, each of which can appear in any order within the TLV message. In some embodiments, TLV elements can be nested within one another, such that one TLV element can include one or more other TLV elements.

In some situations, the flexible nature of TLV messages allows them to be backwards compatible. By way of a non-limiting example, if a receiving application receives a TLV message in a newer format that includes one or more TLV elements it does not recognize, the receiving application can skip or ignore the unrecognized TLV elements, but continue to read the other recognized TLV elements. However, applications generally must be updated with new code to generate and/or understand messages in a new or updated TLV format.

Additionally, in some situations different network components on a network use different message protocols for communication, and in order to communicate with all the other components on a network, a server needs to understand all these different message protocols. In some of these situations, traditionally the server needs to have software to understand each message protocols and/or be loaded with multiple engines that each process different message formats used in the different protocols. Again, updating the server or its engines to process new or revised protocol message formats can be costly and time consuming.

### SUMMARY

What is needed is a message engine that allows the flexible nature of TLV messages to be used with any network element and with any type of TLV-based message protocol. A TLV-based message protocol is a protocol in which each message is defined in TLV format. For such protocols, the message engine can alleviate the need for the network elements to be updated with rewritten code in order to generate and/or process new or updated protocols. Each network element can run a local instance of the message engine, such that its local message engine can act as an interpreter to process incoming and outgoing TLV messages in any protocol. Each message engine can be loaded with configuration files, such as Type Definition Files and Layout Definition Files, associated with a particular protocol that allow the message engine to generate and/or parse TLV message in that protocol, such that the engine can process new or revised protocols by loading new configuration files rather than updating the application itself. By way of non-limiting example, a Type Definition File can be used by a message engine to parse a received TLV message, while a Type Definition Files and a Layout Definition File can be used by a message engine to generate a new TLV message.

In one embodiment, the present disclosure provides for a method of generating a TLV message, the method comprising receiving output from a sender at a message engine, loading one or more configuration files associated with a TLV-based protocol onto the message engine, wherein the one or more configuration files describes information about one or more message elements, generating a TLV message at the message engine by creating and ordering the one or more message elements into a TLV message according to the one or more configurations files, and transmitting the TLV message over a network from the message engine.

In another embodiment, the present disclosure provides for a method of parsing a TLV message, the method comprising receiving a TLV message comprising a plurality of message elements at a message engine linked to a receiver, wherein the TLV message was generated according to a protocol, loading a type definition file associated with the protocol onto the message engine, the type definition file describing information about the plurality of message elements, using the type definition file to parse the message elements of the TLV message into parsed data in another format that is compatible with the receiver, and transmitting the parsed data to the receiver.

In still another embodiment, the present disclosure provides for a message engine, the message engine comprising a Message Generator and Parser configured to load one or more configuration files associated with a protocol that describe information about a plurality of TLV Elements within a TLV Message, and a Message Data Container configured to process the TLV Message according to the protocol.

### BRIEF DESCRIPTION OF THE DRAWINGS

Further details of the present invention are explained with the help of the attached drawings in which:

FIG. 1 depicts an exemplary embodiment of a TLV Message.

FIG. 2 depicts an exemplary embodiment of a TLV Element having nested sub-TLV Elements.

FIG. 3 depicts an exemplary interaction between a sender and a receiver using intermediate TLV Engines.

FIG. 4 depicts exemplary interactions between a client-side TLV Engine and a server-side TLV Engine during the exchange of request and response messages.

FIG. 5 depicts an exemplary embodiment of a TLV Engine.

FIG. 6 depicts a TLVElement class that can be used by a TLV Engine.

FIG. 7 depicts a TLVDataCollection class that can be used by a TLV Engine.

FIG. 8 depicts an exemplary embodiment of a Type Definition File.

FIG. 9 depicts an exemplary embodiment of a Layout Definition File.

FIG. 10 depicts an exemplary embodiment of a Layout Definition File into which other Layout Definition Files are nested.

FIG. 11 depicts an exemplary TLV Message structured according to the Layout Definition File of FIG. 10.

FIGS. 12 and 13 depict screenshots of an embodiment of a configuration file editor.

FIG. 14 depicts a flowchart of a method of creating and distributing configuration files.

FIG. 15 depicts a flowchart of a method of generating a TLV Message according to configuration files.

FIG. 16 depicts a flowchart of a method of parsing a received TLV Message according to configuration files.

FIG. 17 depicts an exemplary embodiment of a computer system.

### DETAILED DESCRIPTION

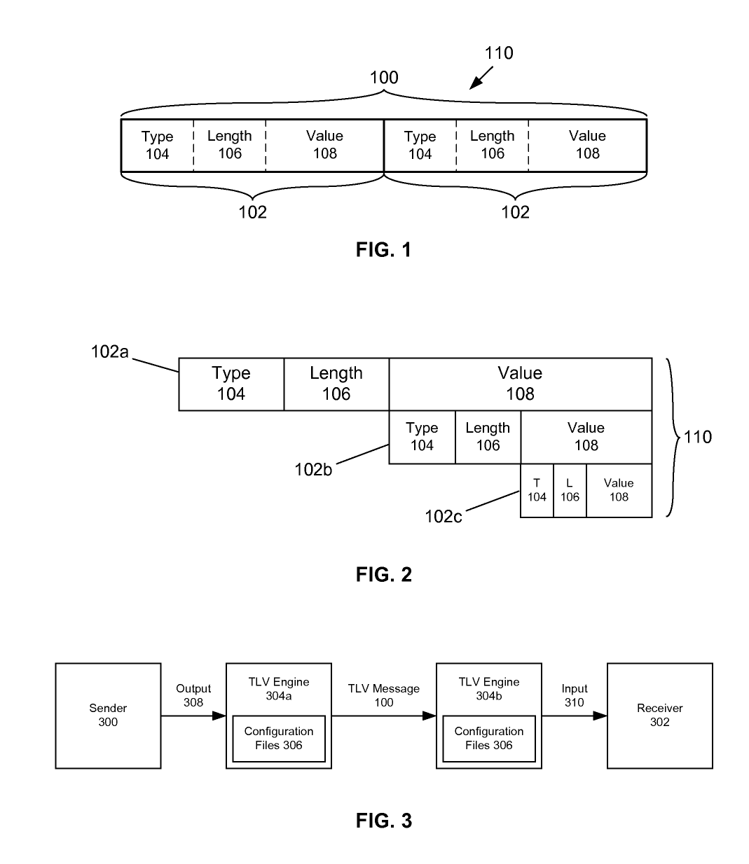

FIG. 1 depicts an exemplary embodiment of a TLV Message 100. A Type-Length-Value (TLV) Message 100 can be a digital message sent between two devices and/or applications that comprises one or more pieces of information or data, known as TLV Elements 102. Each TLV Element 102 within a particular TLV Message 100 can be encoded as a tuple including a type 104 or tag, a length 106, and a value 108. The type 104 or tag of a particular TLV Element 102 can be a binary code that represents the TLV Element 102's type. The length 106 of a particular TLV Element 102 can be a binary code that represents the size of the data in the TLV Element's value 108. In some embodiments, the type 104 and/or length 106 can each have a fixed size. By way of a non-limiting example, the size of the type 104 and length 106 can each be set at 4 bytes. The value 108 can be the data payload of the TLV Element 102. By way of non-limiting examples, the value 108 can be data such as a number value in integer, double, long, float, or any other format, a string of characters, binary data, or a complete sub-TLV Element 102 that has its own type 104, length 106, and value 108. As discussed above, the value 108 can have any size, which is described by the TLV Element's length 106.

As shown in FIG. 2, in some embodiments individual TLV Elements 102 can be nested within one another, such that a single TLV Element 102 can comprise one or more sub-TLV Elements 102. Each sub-TLV Element 102 can be a complete TLV Element 102 that is located within the value 108 field of another TLV Element 102, and thus has its own type 104, length 106, and value 108. In some embodiments, the value 108 field of one sub-TLV Element 102 can contain one or more sub-TLV Elements 102 of its own. By way of a non-limiting example, FIG. 2 depicts a TLV Element 102a that has a sub-TLV Element 102b within its value 108, and a sub-TLV Element 102c within the value 108 of sub-TLV Element 102b. A TLV Element 102 that contains one or more sub-TLV Elements 102 within its value 108 field can be referred to as a Parent TLV Element. Relationships between a TLV Element 102 and one or more levels of nested sub-TLV Elements 102 can be described as parent relationships, grandparent relationships, great-grandparent relationships, or any other type of relationship.

In general, the concept of TLV Messages 100 allows a flexible framework because the individual TLV Elements 102 can be arranged in any order within the message. However, due to this flexibility different kinds of TLV Messages 100 might not have the same types of TLV Elements 102, the same number of TLV Elements 102, or have the TLV Elements 102 arranged or nested in the same order. The particular types, order, and/or nesting of TLV Elements 102 that are used for a particular TLV Message 100 can be defined by or be described by a protocol 110. The protocol 110 can indicate the layout of TLV Elements 102 within a TLV Message 100, and therefore allow a device or application to read and/or generate TLV Messages in that particular protocol 110.

FIG. 3 depicts an exemplary interaction between a sender 300 and a receiver 302 using intermediate TLV Engines 304. Senders 300 and/or receivers 302 can be hardware and/or software elements that can be in data communication directly and/or over a network. By way of non-limiting examples, senders 300 and receivers 302 can be servers or clients, and/or applications running on servers or clients. Servers can be repositories of data, while clients can be devices that request data from the servers, such as computers, mobile devices, mobile phones, cable boxes, gaming consoles, or any other device that can communicate with a server.

A TLV Engine 304 can be used to allow a device or application to send and/or receive TLV Messages 100 in protocols 110 that it does not natively understand or has not been updated to use. A TLV Engine 304 can be a generic module that uses configuration files 306 to process TLV Messages 100 in any protocol 110. Configuration files 306 can be files associated with a particular protocol 110 that describe the types of TLV Elements 102 and/or the layout of the arrangement of TLV Elements 102 within the TLV Message 100 of that protocol 110. Configuration files 306 associated with a protocol 110, such as existing, new, or revised protocols 110 can be loaded onto and used by a TLV Engine 304 to allow the TLV Engine 304 to process TLV Messages 100 in that existing, new, or revised protocol 110, even if the device or application linked to the TLV Engine 304 does not natively understand TLV Messages 100 in that protocol 110.

In some embodiments, the sender 300 and receiver 302 can each be linked to its own TLV Engine 304. A TLV Engine 304 linked to a sender 300 or receiver 302 can allow the sender 300 or receiver 302 to process TLV Messages 100 in any protocol 110 by loading the configuration files 306 associated with the protocol 110. By way of non-limiting examples, a TLV Engine 304 linked to a sender 300 can use configuration files 306 to generate a new TLV Message 100 in a particular protocol 110, and a TLV Engine 304 linked to a receiver 302 can use configuration files 306 to parse or convert a received TLV Message 100 in the protocol 110 described by the configuration files into a different format usable by the receiver 302. In some embodiments, the protocol 110 used by the respective TLV Engines 304 can be pre-determined, while in other embodiments the TLV Message 100 can include an indicator of which protocol 110 was used during its generation.

Each TLV Engine 304 can access and load the configuration files 306 associated with any of a plurality of protocols 110 to process TLV Messages 100 of that protocol 110. In some embodiments, each TLV Engine 304 can maintain its own database of configuration files 306. In other embodiments, each TLV Engine 304 can access a separate repository of configuration files 306. A TLV Engine 304, and by extension the sender 300 or receiver 302 linked to the TLV Engine 304, can be made compatible with new or revised protocols 110 by loading new or revised configuration files 306 rather than updating existing software or firmware on the sender 300, receiver 302, or TLV Engine 304.

As shown in FIG. 3, the sender 300 can transmit data to the receiver 302 using intermediate TLV Engines 304 linked to the sender 300 and receiver 302. By way of a non-limiting example, the sender 300 can desire to transmit a data object to the receiver 302. The sender 300 can pass output 308 to the TLV Engine 304a linked to the sender 300. In some embodiments, the sender 300 can convert the data object it desires to send into a generic data structure, which it passes to the TLV Engine 304a as output 308. By way of a non-limiting example, the sender 300 can use properties and/or methods provided by the TLV Engine 304a to convert the data object it wants to send into the generic data structure of a TLV Element 102, and passes the TLV Element 102 to the TLV Engine 304 as output 308. The sender's TLV Engine 304a can load configuration files 306 associated with a particular protocol 110, and can generate a new TLV Message 100 by converting the sender's output 308 into a TLV Message 100 in the format indicated by the particular protocol 110. By way of a non-limiting example, the TLV Engine 304a can convert a generic data structure output by the sender 300 into a serialized binary message stream in a protocol 110 as defined by the loaded configuration files 306. The new TLV Message 100 can be sent from the sender's TLV Engine 304a to the receiver's TLV Engine 304b. The receiver's TLV Engine 304b can load configuration files 306 for the protocol 110, and use the configuration files 306 to parse the received TLV Message 100 from the protocol 110 into a format usable by the receiver 302. By way of a non-limiting example, the receiver's TLV Engine 304b can convert the received TLV Message 100 from a serialized binary message stream into a generic data structures, such as discrete TLV Element 102, from which the receiver can extract data.

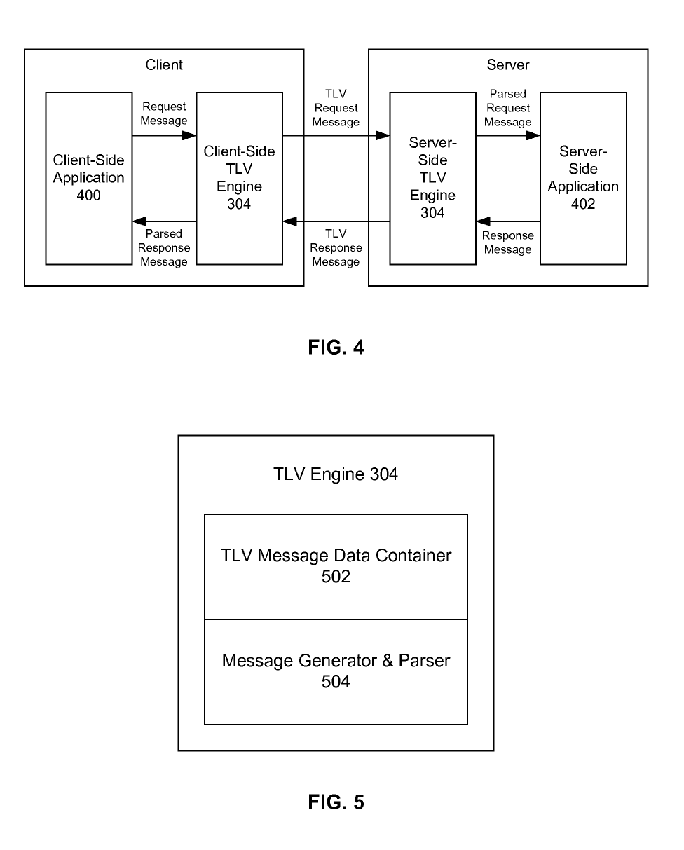

In some embodiments, hardware and/or software elements that communicate via TLV Engines 304 can alternate between acting as the sender 300 and the receiver 302 during a back and forth exchange of information. By way of a non-limiting example, FIG. 4 depicts interactions between applications running on a client and a server, in which the client-side application 400 requests data from the server-side application 402 and the server-side application 402 sends a response back to the client-side application 400. In this example, the client-side application 400 and the server-side application 402 can use respective TLV Engines 304 to exchange TLV Messages 100.

In this example, a client-side application 400 can initially act as the sender 300, and can output a request message to the client-side TLV Engine 304. The client-side TLV Engine 304 can load and use configuration files 306 to convert the client-side application's request message into a TLV Request Message in a particular protocol 110. The TLV Request Message can then be sent from the client-side TLV Engine 304 to the server-side TLV Engine 304. The server-side TLV Engine 304 can load and use configurations files 306 for the protocol 110 associated with the received TLV Request Message to parse the received TLV Request Message into a Parsed Request Message that can be passed to and be understood by the server-side application 402, which acts as a receiver 302. The server-side application 402 can process the Parsed Request Message and output a response message to the server-side TLV Engine 304, thereby becoming a sender 300. The server-side TLV Engine 304 can load and use configuration files 306 to convert the server-side application's response message into a TLV Response Message in a particular protocol 110. The TLV Request Message can then be sent from the server-side TLV Engine 304 to the client-side TLV Engine 304. The client-side TLV Engine can load and use configurations files 306 for the protocol 110 associated with the received TLV Response Message to parse the TLV Response Message into a Parsed Response Message that can be passed to and be understood by the client-side application 400, which now acts as a receiver 302.

FIG. 5 depicts a non-limiting example of an embodiment of a TLV Engine 304. In some embodiments, a TLV Engine 304 can comprise a TLV Message Data Container 502 and a Message Generator and Parser 504. The TLV Message Data Container 502 can be an object-oriented class that comprises properties and/or methods to create a generic data structure, such as a TLV Element 102. The Message Generator and Parser 504 can load and use configuration files 306 to generate and/or parse a TLV Message 100 comprising a plurality of TLV Elements 102.

The TLV Message Data Container 502 can be a class that describes properties of a TLV Element 102, such as its type 104, length 106, and/or characteristics of its value 108. The TLV Message Data Container 502 can also describe or reference methods for creating a TLV Element 102, creating or adding sub-TLV Elements 102 into a parent TLV Element's value 108, and/or finding TLV Elements 102 within a TLV Message 100 or a parent TLV Element 102. By way of a non-limiting example, the properties and methods of the TLV Message Data Container 502 can be used by a sender 300 to construct TLV Elements 102 from data it desires to send to a receiver 302.

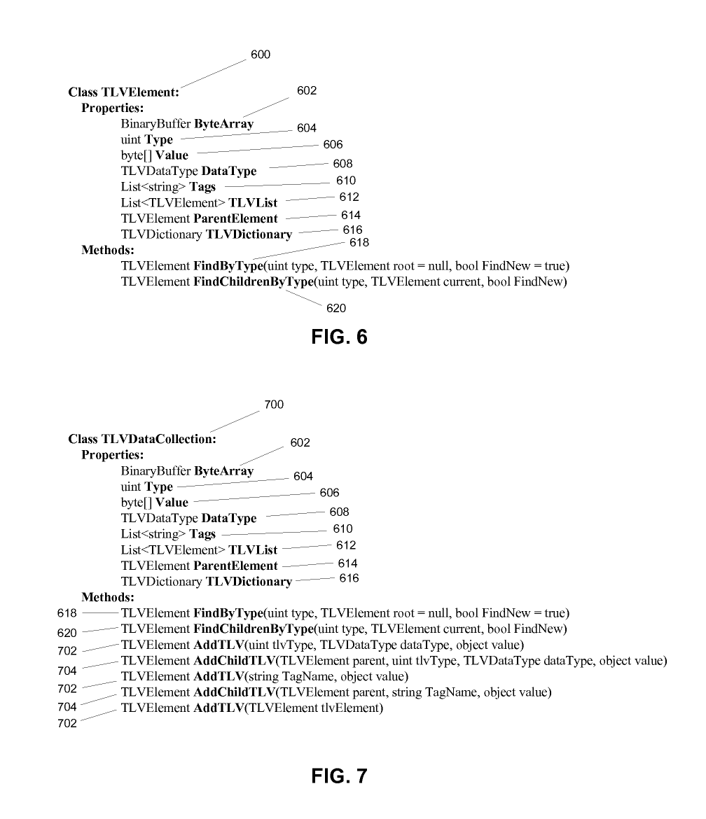

By way of a non-limiting example, in some embodiments a TLVElement class 600 can be used as the TLV Message Data Container 502, as shown in FIG. 6. The TLVElement Class 600 can have one or more properties, including ByteArray 602, Type 604, Value 606, DataType 608, Tags 610, TLVList 612, ParentElement 614, and/or TLVDictionary 616.

ByteArray 602 can indicate a combination of a particular TLV Element's type 104, length 106, and value 108 in a byte array format. Type 604 can indicate the type 104 of a particular TLV Element 102. Value 606 can indicate the value 108 of a particular TLV Element 102. In some embodiments, the length of Value 606 can indicate the length 106 of a particular TLV Element 102.

DataType 608 can indicate the data type of a particular TLV Element 102, such as the data type of the TLV Element's value 108. DataType 608 can indicate that the TLV Element's value 108 is: an unsigned byte; an unsigned short integer (2 bytes); an unsigned integer (4 bytes); an unsigned long integer (8 bytes); a signed byte; a signed short integer (2 bytes); a signed integer (4 bytes); a signed long integer (8 bytes); a Float (4 bytes float); a Double (8 bytes float); a variable length ASCII string or binary array; a Compound; and/or any other data type. A Compound data type can indicate that the TLV Element 102 includes one or more nested sub-TLV Elements 102 as children within its value 108.

Tags 610 can be a string array that can indicate a particular TLV Element's tag 802 and, if the TLV Element 102 is a sub-TLV Element 102 and therefore has a parent TLV Element 102, a list of the tags 802 of a sub-TLV Element's parent, grandparent, or other ancestor TLV Element 102. As will be discussed below, a tag 802 can be a shorthand identifier of a TLV Element's type 104.

TLVList 612 can be a list that indicates child sub-TLV Elements 102 that are associated with a particular TLV Element 102. By way of a non-limiting example, if a TLV Element 102 has one or more child sub-TLV Elements 102, TLVList 612 can identify the child sub-TLV Elements 102, such that TLVList 612 can be used to generate a nested structural layout of TLV Elements 102.

ParentElement 614 can indicate tags 802 of a sub-TLV Element's parent TLV Element 102, if a particular TLV Element 102 has a parent TLV Element 102.

TLVDictionary 616 can be a copy of configuration files 306 stored in memory, such that the configuration files 306 can be looked up for information on the type or layout of a TLV Element 102 within a TLV Message 100.

The TLVElement Class 600 can also include one or more methods, including FindByType 618, and/or FindChildrenByType 622. FindByType 618 can be a method of finding TLV Elements 102 by their type 104. FindChildrenByType 620 can be a method of finding sub-TLV Elements 102 by their type 104.

As another non-limiting example, in other embodiments a TLVDataCollection class 700 can be used as the TLV Message Data Container 502, as shown in FIG. 7. The TLVDataCollection class 700 can be a sub-class derived from the TLVElement class 600. The TLVDataCollection class 700 can have some or all of the same properties and/or methods of the TLVElement class 600, with additional methods such as AddTLV 702 and AddChildTLV 704. AddTLV 702 can be a method of adding a new TLV Element 102 into an existing TLV Message 100. AddChildTLV 704 can be a method of adding a sub-TLV Element 102 into a parent TLV Element 102.

The Message Generator and Parser 504 can be a module that constructs and/or interprets TLV Messages 100 based on configuration files 306. The Message Generator and Parser 504 can process any TLV Message 100 in any protocol 110 by loading and using the configuration files 306 associated with the protocol 110, such that it can generate a new TLV Message 100 in that protocol 110 or parse a received TLV Message 100 in that protocol 110 into a different format. By way of a non-limiting example, the Message Generator and Parser 504 can have a message generator that takes TLV Elements 102 as input, combines them into a TLV Message 100 according to configuration files 306 such as Type Definition Files 800 and/or Layout Definition Files 900, and outputs a complete TLV Message 100. The Message Generator and Parser 504 can also have a message parser that takes a complete TLV Message 100 as input, parses it into its individual component TLV Elements 102 according to Type Definition Files 800, and then outputs the component TLV Elements 102.

In some embodiments, configuration files 306 for a particular protocol 110 can comprise Type Definition Files 800 and/or Layout Definition Files 900. The Type Definition Files 800 can be used both in the generating and parsing of TLV Messages 100, while the Layout Definition Files 900 can be used during the generation of TLV Messages 100.

A Type Definition File 800 can describe attributes and/or details of a TLV Element 102 of a particular type 104. A Layout Definition File 900 can describe the structural location of a TLV Element 102 of a particular type 104 within an overall TLV Message 100. By way of a non-limiting example, a TLV Message 100 can comprise multiple TLV Elements 102 each of a different type 104. The Type Definition File 800 and Layout Definition File 900 associated with a particular type 104 can describe the details of a TLV Element 102 having that type 104, such as the type of data it contains, and the position of a TLV Element 102 having that type 104 within the overall TLV Message 100, such as the identities of its parents and/or children.

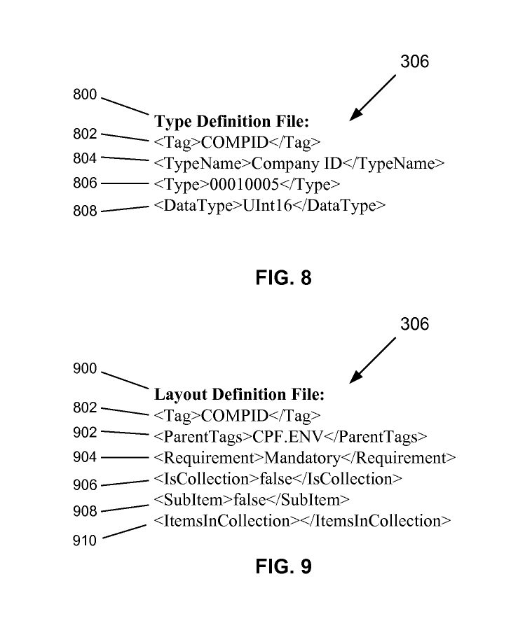

In some embodiments, a protocol 110 can be associated with a plurality of Type Definition Files 800 and a plurality of Layout Definition Files 900, with one Type Definition File 800 and one Layout Definition File 900 for each type 104 of TLV Element 102 used by the protocol 110. In alternate embodiments, the attributes and/or locations of multiple types 104 of TLV Elements 102 can be combined into a single Type Definition File 800 and/or Layout Definition File 900 associated with a protocol 110. In some embodiments, configuration files 306 can be stored and accessed as Extensible Markup Language (XML) files. Non-limiting exemplary embodiments of a Type Definition File 800 and a Layout Definition File 900 are shown in FIGS. 8 and 9.

A Type Definition File 800 can define the attributes of a type 104 of TLV Element 102 used by particular protocol 110. The Message Generator and Parser 504 can load a Type Definition File 800 that contains information about a type 104 of TLV Element 102 to create and/or parse a TLV Element 102 of that type 104 within a larger TLV Message 100. In some embodiments, a Type Definition File can comprise one or more of the following fields: Tag 802, TypeName 804, Type 806, and/or DataType 808.

Tag 802 can be a short name for the type 104 of the TLV Element 102. In some embodiments, Tag 802 can be an abbreviated or shorter version of TypeName 804, described below. By way of a non-limiting example, in FIG. 8 the Tag 802 is “COMPID.” In some embodiments, the tag 802 associated with a type 104 can also be used as a shorthand identifier for the same type 104 within a TLV Message Data Container 502, such as the TLVElement class 600, and/or a Layout Definition File 900. By way of a non-limiting example, a tag 802 can be used consistently within a protocol 110 to link or refer to different configuration files 306 associated with the type 104 referred to by the tag 802, and/or refer to the identities and/or relationships of TLV Elements 102 by referring to their tags 802.

TypeName 804 can be a name and/or description of the type 104 of the TLV Element 102. By way of a non-limiting example, in FIG. 8 the TypeName 804 is “Company ID.”

Type 806 can be an identifier of the type 104 of the TLV Element 102. In some embodiments, Type 806 can be a predefined hexadecimal value assigned to a particular type 104. By way of a non-limiting example, in FIG. 8 the Type 806 is “00010005.” As mentioned above, a type 104 can be referred to by other components or elements of a protocol 110 or TLV Engine 304 alternately or interchangeably by a tag 802 associated with the type 104.

DataType 808 can be a representation of a data type associated with the type 104 of the TLV Element 102. As discussed above with respect to FIG. 6 and DataType 608 within the TLVElement class 600, a TLV Element's value 108 can include data of any data type, such as an unsigned byte; an unsigned short integer (2 bytes); an unsigned integer (4 bytes); an unsigned long integer (8 bytes); a signed byte; a signed short integer (2 bytes); a signed integer (4 bytes); a signed long integer (8 bytes); a Float (4 bytes float); a Double (8 bytes float); a variable length ASCII string or binary array; a Compound; and/or any other data type. Referring back to FIG. 8, DataType 808 can indicate the particular data type associated with a particular type 104 of TLV Element 102. By way of a non-limiting example, in FIG. 8 the DataType 808 for the type 104 indicated by the “COMPID” tag 802 is “UInt16,” denoting a 16-bit unsigned integer.

A Layout Definition File 900 associated with a protocol 110 can define the structural relationships between particular TLV Elements 102 within a TLV Message 100 generated according to that protocol 110. By way of a non-limiting example, a Layout Definition File 900 can indicate nesting relationships of TLV Elements 102 and/or collections of TLV Elements 102 within a parent TLV Element 102. In some embodiments, a Layout Definition File 900 can comprise one or more of the following fields: Tag 802, ParentTags 902, Requirement 904, IsCollection 906, Subltem 908, and/or ItemsInCollection 910.

Tag 802 within a Layout Definition File 900 can indicate a tag 802 associated with a type 104 of TLV Element 102. As discussed above, the tag 802 can be used as a common identifier of different types of configuration files 306 associated with a particular type 104 of TLV Element 102, and/or as a shorthand to refer to TLV Elements 102 having that type 104. By way of a non-limiting example, in FIG. 9 the Tag 802 is “COMPID,” just as the Tag 802 in the associated Type Definition File 800 shown in FIG. 8 is also “COMPID,” thereby indicating that the Type Definition File 800 of FIG. 8 and the Layout Definition File 900 of FIG. 9 both refer to the same type 104. A Layout Definition File 900 and a Type Definition File 800 that have the same tag 802 can therefore be linked, with the Layout Definition File 900 indicating the nesting position of a TLV Element 102 that has the tag 802 and the Type Definition File 800 indicating the details of the type 104 associated with the tag 802.

ParentTags 902 can be string of tags 802 that denote the tags 802 of a sub-TLV Element's parent TLV Elements 102, grandparent TLV Elements 102, or other ancestor TLV Elements 102 within which the sub-TLV Element 102 is nested. ParentTags 902, by denoting the tags of a TLV Element's ancestors, thereby indicates a TLV Element's nested structural position within an overall TLV Message 100. In some embodiments, the tags 802 of each ancestor TLV Element 102 for the nested sub-TLV Element described by the Layout Definition File 900 can be separated by a dot within the ParentTags 902 field, with higher-level TLV Elements 102 appearing first in the string. By way of a non-limiting example, ParentTags 902 in FIG. 9 indicates that a TLV Element 102 associated with the “COMPID” tag 802 has a grandparent TLV Element 102 described by the “CPF” tag and a parent TLV Element 102 described by the “ENV” tag.

Requirement 904 can indicate whether the existence of a TLV Element 102 corresponding to the tag 802 is mandatory, conditional, or optional within a TLV Message 100. By way of a non-limiting example, Requirement 904 in FIG. 9 indicates that a TLV Element 102 matching the tag 802 described by the Layout Definition File 900 is mandatory within the overall TLV Message 100.

IsCollection 906 can be a boolean flag indicating whether there can be multiple TLV Elements 102 of the same type 104 nested as children within the same parent TLV Element 102. If IsCollection 906 for a particular tag 802 is set to “false” within a Layout Definition File 900, then there is only one child TLV Element 102 of that particular tag 802 nested within its parent TLV Element 102. However, if IsCollection 906 is set to “true” for a particular tag 802 within a Layout Definition File 900, then there can be, but do not have to be, additional TLV Elements 102 of the same type 104 nested as children within in the same parent TLV Element 102. By way of a non-limiting example, IsCollection 906 can be set to “true” even if there is only one child TLV Element 102 matching the tag 802 within a parent TLV Element 102, but the “true” flag allows additional TLV Elements 102 of the same tag 802 to be added later as children into the same TLV Element 102.

SubItem 908 can be a boolean flag indicating whether a particular TLV Element 102 must have a parent TLV Element 102 within the overall layout of the TLV Message 100, and that the value 108 of the TLV Element 102 can be found within that parent TLV Element 102. By way of a non-limiting example, in some instances there can be multiple TLV Elements 102 of the same type 104 within a TLV Message 100, with each one nested as a child within different parent TLV Element 102. Setting SubItem 908 to “true” can indicate that the child TLV Element's parent TLV Element 102 holds the value of the child TLV Element 102. Setting SubItem 908 to “false” can indicate that the TLV Element 102 does not necessary have a parent, or that the value 108 of the TLV Element 102 can be found within the TLV Element 102 itself.

ItemsInCollection 910 can be included within a Layout Definition File 900 if IsCollection 906 is set to “true” and the data type of the TLV Element 102 is “Compound,” indicating that a TLV Element 102 has a collection of sub-TLV Elements 102 nested within it. ItemsInCollection 910 can include references to, and/or complete Layout Definition Files 900 of sub-TLV Elements 102 that are nested within the TLV Element 102 described by the Layout Definition File 900 and its associated Type Definition File 800.

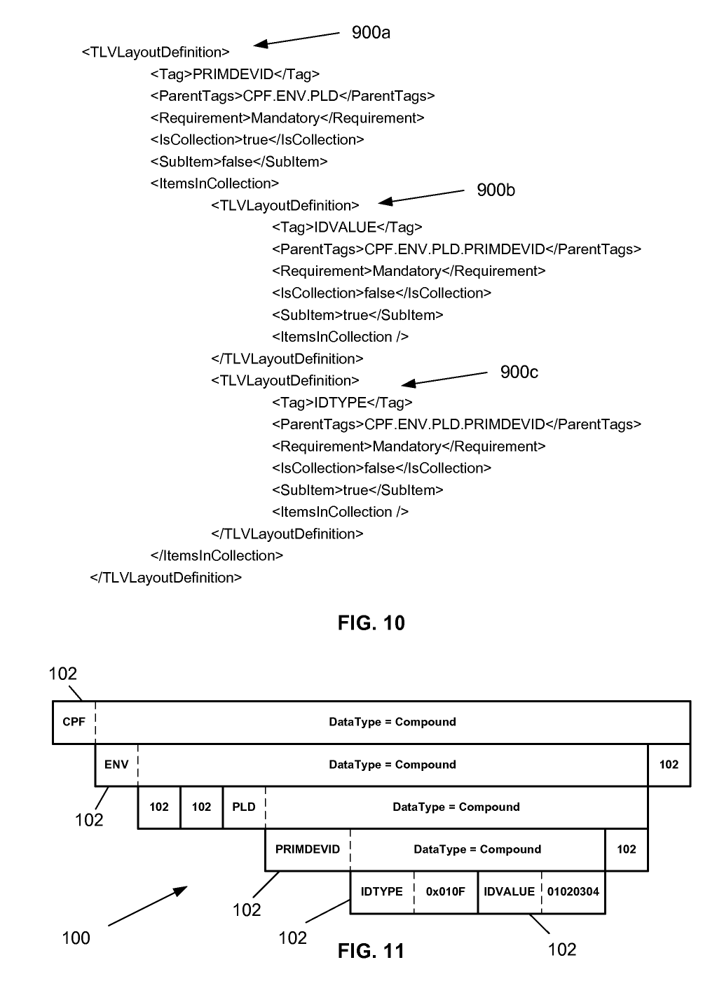

By way of another non-limiting example, FIG. 10 depicts an exemplary Layout Definition File 900a for a “PRIMDEVID” tag 802, and FIG. 11 depicts a TLV Message 100 that includes TLV Elements 102 in positions described by the Layout Definition File 900 of FIG. 10. As can be seen from FIG. 10, the Layout Definition File 900a describes the positioning of a TLV Element 102 having the “PRIMDEVID” tag 802. The ParentTags 902 field indicates that “PRIMDEVID” has “PLD” as its parent TLV Element 102, “ENV” as its grandparent TLV Element 102, and “CPF” as its great-grandparent TLV Element 102, and this structural layout can be seen in FIG. 11. As can be seen from FIG. 10, IsCollection 906 is set to “true” for “PRIMDEVID,” indicating that there can, be do not have to be, additional “PRIMDEVID” TLV Elements 102 within the parent “PLD” TLV Element 102. Layout Definition Files 900 for the child sub-TLV Elements “IDVALUE” and “IDTYPE” are included within the “PRIMDEVID” TLV Element's ItemsInCollection 910 field. The child “IDVALUE” and “IDTYPE” TLV Elements 102 can be seen in a nesting position within “PRIMDEVID” value 108 in FIG. 11. As can be seen from FIG. 10, SubItem 908 is set to “true” for each of “IDVALUE” and “IDTYPE.” This indicates that “IDVALUE” and “IDTYPE” must have parents, and the values 108 of the “IDVALUE” and “IDTYPE” TLV Elements 102 will be found in the value 108 of the parent TLV Element 102 identified within ParentTags 902. Because other TLV Elements 102 within the overall TLV Message 100 can also have child TLV Elements 102 with the “IDVALUE” and “IDTYPE” tags 802, the combination of SubItem 908 and ParentTags 902 can indicate which parent holds the value 108 for a particular instance of “IDVALUE” or “IDTYPE.”

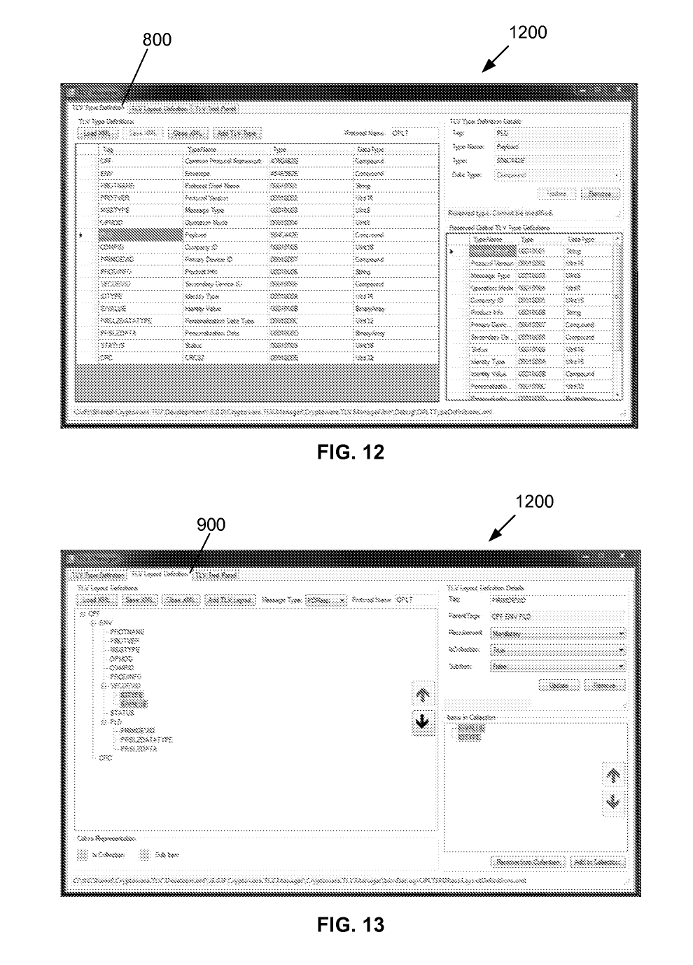

FIGS. 12 and 13 depict an exemplary embodiment of a configuration file editor 1200. Configuration files 306 can be created and/or edited using a configuration file editor 1200. By way of a non-limiting example, a user can use a configuration file editor 1200 to edit a Type Definition File 800 to change the properties of a type 104 of TLV Element 102 associated with a protocol, such as changing its data type, as shown in FIG. 12. By way of another non-limiting example, a user can use a configuration file editor 1200 to edit Layout Definition Files 900 to change the nesting and structural parent-child relationships between TLV Elements 102 within the overall layout of a TLV Message 100, as shown in FIG. 13.

In some embodiments, a configuration file editor 1200 can be an application with a graphic user interface that allows configuration files 306 such as Type Definition Files 800 and Layout Definition Files 900 to be created and/or edited, as shown in FIGS. 12 and 13. In other embodiments, a configuration file editor 1200 can be a command line application, an application that allows configuration files 306 to be loaded and edited directly, or any other type of application that allows editing of configuration files 306.

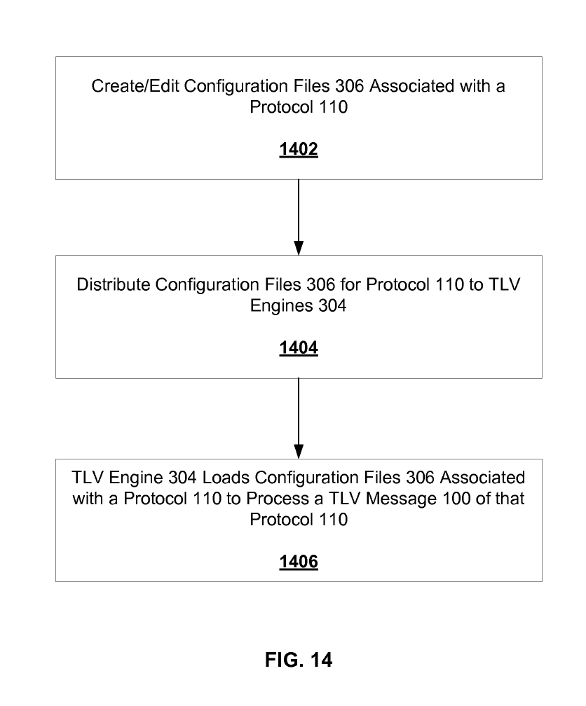

FIG. 14 depicts a flowchart of a process for distributing new or updated configuration files 306 to TLV Engines 304. As mentioned above, configuration files 306 can be associated with a protocol 110, and TLV Engines 304 can be made compatible with new or updated protocols 110 by loading configuration files 306 corresponding to the new or updated protocol 110 onto the TLV Engines 304.

At step 1402, configuration files 306 associated with a protocol 110 can be created and/or updated. By way of a non-limiting example, configuration files 306 for a new or revised protocol 110 can be created and/or edited with a configuration file editor 1200.

At step 1404, the new or revised configuration files 306 can be distributed to TLV Engines 304 linked to network elements such as senders 300 and receivers 302. As discussed above with respect to FIGS. 3 and 4, hardware elements and/or applications running on hardware elements can act as senders 300 and/or receivers 302. The senders 300 and/or receivers 302 can each be linked to local TLV Engines 304 to process incoming and outgoing TLV Messages 100. The new or revised configuration files 306 created during step 1402 can be distributed during step 1404 to each local TLV Engine 304 that is anticipated to process TLV Messages 100 in the protocol 110 associated with the new or revised configuration files 306.

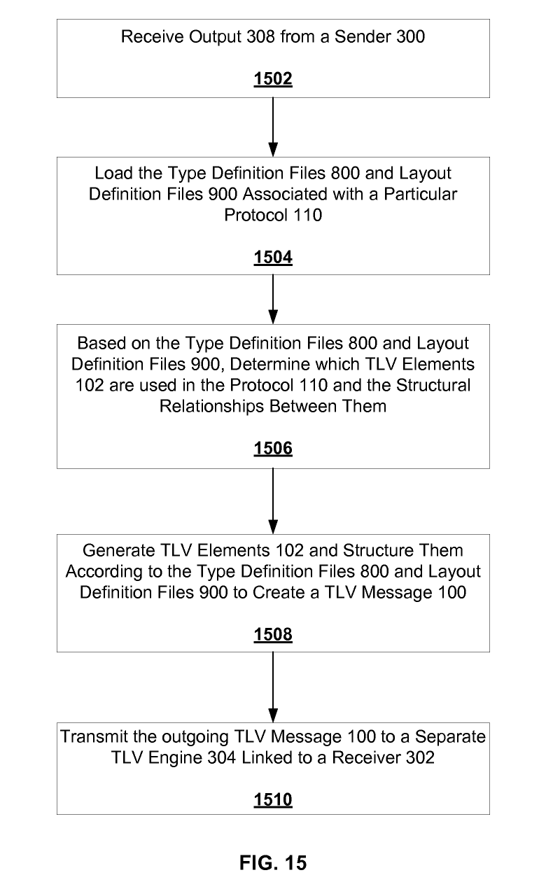

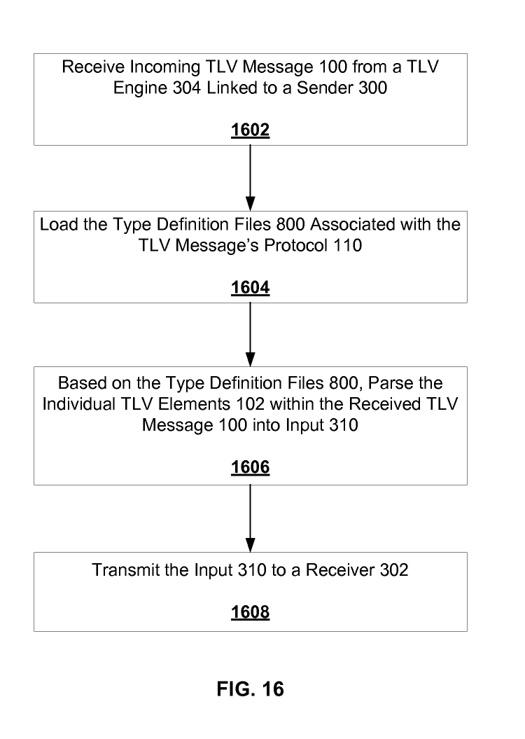

At step 1406, a local TLV Engine 304 can load configuration files 306 associated with a protocol 110 to process a TLV Message 100 in that protocol. By way of a non-limiting example, the local TLV Engine 304 can follow the steps of FIG. 15 or FIG. 16 to generate a new TLV Message 100 or parse a received TLV Message 100.

FIGS. 15 and 16 respectively depict flowcharts for methods of generating a new TLV Message 100 and parsing a received TLV Message 100. As discussed above, in some embodiments the TLV Engine 304 can load both Type Definition Files 800 and Layout Definition Files 900 to generate a TLV Message 100, while the TLV Engine 304 only loads Type Definition Files 800 to parse or convert a received TLV Message 100.

FIG. 15 depicts a method of generating a new TLV Message 100. At step 1502, a local TLV Engine 304 linked to a sender 300 can receive output 308 from the sender 300. In some embodiments, the sender 300 can call public methods in the TLV Message Data Container 502 to convert a data object from the sender 300 into a generic file structure, such as a TLV Element 102, which can then be passed as output 308 to the TLV Engine 304.

At step 1504, the local TLV Engine 304 can load configuration files 306 associated with a particular protocol 110 for use by its Message Generator and Parser 504. In some embodiments, the particular protocol 110 to be used can be pre-agreed upon between the sender 300 and receiver 302, or agreed upon or determined by a network operator or other user who has control over the sender 300 and/or receiver 302. In alternate embodiments, the particular protocol 110 can be any desired protocol 110, and the resulting TLV Message 100 can include an indicator of what protocol 110 was used during generation of the TLV Message 100. The configuration files 306 loaded by the local TLV Engine 304 can be one or more Type Definition Files 800 and one or more Layout Definition Files 900 associated with the protocol 110 that is to be used.

At step 1506, the local TLV Engine 304 can use the Layout Definition Files 900 to determine which TLV Elements 102 are to be used in a TLV Message 100 of the chosen protocol 110, and in the nesting parent-child relationships of the TLV Elements 102. By way of a non-limiting example, FIG. 9 indicates that in one exemplary protocol 110, a TLV Element 102 having a tag 802 of “COMPID” is mandatory, as indicated by Requirement 904, and has parent and grandparent TLV Elements 102, as indicated by ParentTags 902. The local TLV Engine 304 can also use the Type Definition Files 800 to determine the characteristics of each individual TLV Element 102 used in the layout described by the Layout Definition Files 900, such as the data types of the TLV Elements 102.

At step 1508, the Message Generator and Parser 504 can assemble the TLV Elements 102 received from the sender 300 into a TLV Message 100 according to the Type Definition Files 800 and Layout Definition Files 900, including nesting TLV Elements 102 within other TLV Elements 102 as children, grandchildren or other relationships as described by the Layout Definition Files 900.

At step 1510, the TLV Message 100 generated during step 1508 can be transmitted to a separate TLV Engine 304 linked to a receiver 302. By way of a non-limiting example, in FIG. 3 the generated TLV Message can be sent from the TLV Engine 304a linked to the sender 300 to the TLV Engine 304b linked to the receiver 302. In alternate embodiments, the TLV Message 100 can be transmitted to a receiver 302 that is not linked to its own local TLV Engine 304, such as if the receiver 302 has been directly updated or configured to receive and understand TLV Messages 100 in the TLV Message's protocol 110.

FIG. 16 depicts a method of receiving a new TLV Message 100 and parsing it into discrete TLV Elements 102 as in Input 310. At step 1602, a local TLV Engine 304 linked to a receiver 302 can receive a TLV Message 100 from a TLV Engine 304 linked to a sender 300. In alternate embodiments, the TLV Message 100 can be received from a sender 300 that has been directly updated or configured to output TLV Messages 100 in a particular protocol 110 without an intermediate TLV Engine 304 linked to the sender 300.

At step 1604, one or more Type Definition Files 800 associated with the received TLV Message's protocol 110 can be loaded for use by the Message Generator and Parser 504. As mentioned with respect to step 1504, in some embodiments the protocol 110 used for TLV Messages 100 sent between a sender 300 and receiver 302 can have been pre-determined. In alternate embodiments, the received TLV Message 100 can comprise an indicator of which protocol 110 was used during generation of the TLV Message 100.

At step 1606, the received TLV Message 100 can be parsed into Input 310 that is understandable by the receiver 302. As the received TLV Message 100 already has a structural layout and is received as a binary array, in some embodiments the Layout Definition Files 900 associated with the protocol 110 are not loaded or used, and the received TLV Message 100 can be parsed by looking for the tags 802 of each successive TLV Element 102 in the binary array of the received TLV Message 100 and loading and using the Type Definition File 800 for each respective tag 802 to understand the data in each TLV Element 102 and parse the received TLV Message 100 into data understandable by the receiver 302. By way of a non-limiting example, the Message Generator and Parser 504 can use the Type Definition Files 800 to find and break the TLV Message 100 into its individual TLV Elements 102, and the individual TLV Elements 102 can be understandable by the receiver 302 as Input 310. In these embodiments Layout Definition Files 900 are not used during parsing of the received TLV Message 100, however in alternate embodiments the Layout Definition Files 900 can be loaded and used to assist in parsing the received TLV Message 100 into Input 310. In some embodiments, the local TLV Engine 304 can use the properties and methods of the TLV Message Data Container 502 to understand or find individual TLV Elements 102 in a TLV Message 100.

At step 1608, the Input 310 created during step 1606 by parsing the received TLV Message 100 according to configuration files 306 can be transmitted to the receiver 302. By way of a non-limiting example, in some embodiments, the Input 310 can be the discrete TLV Elements 102 parsed by the TLV Engine 304 and the receiver can extract data from the value 108 of each TLV Element 102. In other embodiments, the Input 310 can be formatted as a generic data structure, and the receiver 302 can convert the generic data structure of the Input 310 into a data object that the receiver 302 can use and understand.

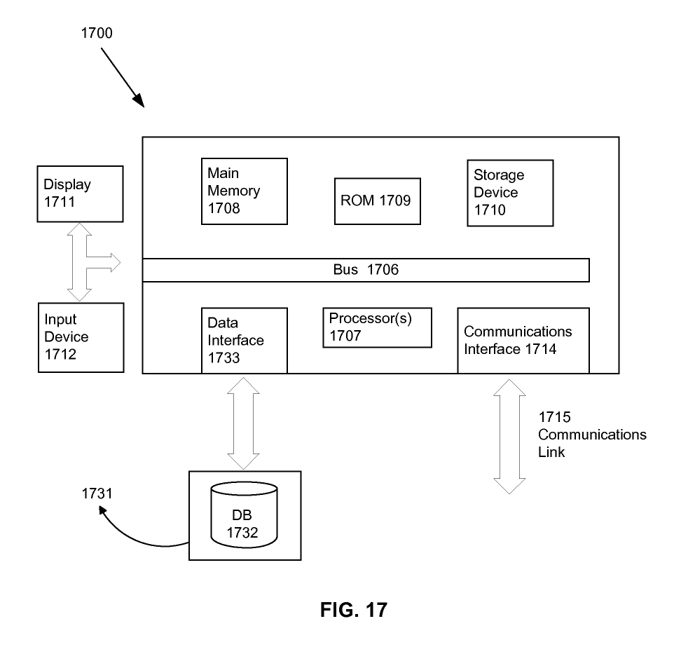

The execution of the sequences of instructions required to practice the embodiments may be performed by a computer system 1700 as shown in FIG. 17. In an embodiment, execution of the sequences of instructions is performed by a single computer system 1700. According to other embodiments, two or more computer systems 1700 coupled by a communication link 1715 may perform the sequence of instructions in coordination with one another. Although a description of only one computer system 1700 may be presented herein, it should be understood that any number of computer systems 1700 may be employed.

A computer system 1700 according to an embodiment will now be described with reference to FIG. 17, which is a block diagram of the functional components of a computer system 1700. As used herein, the term computer system 1700 is broadly used to describe any computing device that can store and independently run one or more programs.

The computer system 1700 may include a communication interface 1714 coupled to the bus 1706. The communication interface 1714 provides two-way communication between computer systems 1700. The communication interface 1714 of a respective computer system 1700 transmits and receives electrical, electromagnetic or optical signals, that include data streams representing various types of signal information, e.g., instructions, messages and data. A communication link 1715 links one computer system 1700 with another computer system 1700. For example, the communication link 1715 may be a LAN, an integrated services digital network (ISDN) card, a modem, or the Internet.

A computer system 1700 may transmit and receive messages, data, and instructions, including programs, i.e., application, code, through its respective communication link 1715 and communication interface 1714. Received program code may be executed by the respective processor(s) 1707 as it is received, and/or stored in the storage device 1710, or other associated non-volatile media, for later execution.

In an embodiment, the computer system 1700 operates in conjunction with a data storage system 1731, e.g., a data storage system 1731 that contains a database 1732 that is readily accessible by the computer system 1700. The computer system 1700 communicates with the data storage system 1731 through a data interface 1733.

Computer system 1700 can include a bus 1706 or other communication mechanism for communicating the instructions, messages and data, collectively, information, and one or more processors 1707 coupled with the bus 1706 for processing information. Computer system 1700 also includes a main memory 1708, such as a random access memory (RAM) or other dynamic storage device, coupled to the bus 1706 for storing dynamic data and instructions to be executed by the processor(s) 1707. The computer system 1700 may further include a read only memory (ROM) 1709 or other static storage device coupled to the bus 1706 for storing static data and instructions for the processor(s) 1707. A storage device 1710, such as a magnetic disk or optical disk, may also be provided and coupled to the bus 1706 for storing data and instructions for the processor(s) 1707.

A computer system 1700 may be coupled via the bus 1706 to a display device 1711, such as an LCD screen. An input device 1712, e.g., alphanumeric and other keys, is coupled to the bus 1706 for communicating information and command selections to the processor(s) 1707.

According to one embodiment, an individual computer system 1700 performs specific operations by their respective processor(s) 1707 executing one or more sequences of one or more instructions contained in the main memory 1708. Such instructions may be read into the main memory 1708 from another computer-usable medium, such as the ROM 1709 or the storage device 1710. Execution of the sequences of instructions contained in the main memory 1708 causes the processor(s) 1707 to perform the processes described herein. In alternative embodiments, hard-wired circuitry may be used in place of or in combination with software instructions. Thus, embodiments are not limited to any specific combination of hardware circuitry and/or software.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed:

1. A method of generating a Type-Length-Value message, comprising:
receiving output from a sender at a message engine;
loading one or more configuration files associated with a Type-Length-Value (TLV)-based protocol onto said message engine, wherein said one or more configuration files describes information about one or more message elements;
generating a TLV message at said message engine by creating and ordering said one or more message elements into a TLV message according to said one or more configurations files; and
transmitting said TLV message over a network from said message engine.

2. The method of claim 1, wherein said TLV message is transmitted from said message engine to a second message engine linked to a receiver.

3. The method of claim 1, wherein one of said one or more configuration files is a type definition file that describes information about a type of one of said one or more message elements.

4. The method of claim 3, wherein said information about said type of one of said one or more message elements describes a data type of said one of said one or more message elements.

5. The method of claim 1, wherein one of said one or more configuration files is a layout definition file that describes information about a structural layout of said one or more message elements within said TLV message.

6. The method of claim 5, wherein said information about said structural layout of said one or more message elements within said TLV message comprises identification of nesting relationships of one or more of said one or more message elements within another one or more of said one or more message elements.

7. The method of claim 1, comprising loading one or more alternate configuration files associated with a different protocol other than said protocol onto said message engine, to configure said message engine to generate a new TLV message in said different protocol by using said one or more alternate configuration files.

8. A method of parsing a Type-Length-Value message, comprising:
receiving a Type-Length-Value (TLV) message comprising a plurality of message elements at a message engine linked to a receiver, wherein said TLV message was generated according to a protocol;
loading a type definition file associated with said protocol onto said message engine, said type definition file describing information about said plurality of message elements;
using said type definition file to parse the message elements of said TLV message into parsed data in another format that is compatible with said receiver; and
transmitting said parsed data to said receiver.

9. The method of claim 8, wherein said type definition file describes data types of said plurality of message elements.

10. The method of claim 8, comprising loading an alternate type definition file associated with a different protocol other than said protocol onto said message engine, to configure said message engine to parse a new TLV message in said different protocol by using said alternate type definition file.

11. A message engine comprising:
a Message Generator and Parser configured to load one or more configuration files associated with a protocol that describe information about a plurality of Type-Length Value (TLV) Elements within a TLV Message; and
a Message Data Container configured to process said TLV Message according to said protocol.

12. The message engine of claim 11, wherein said one of said one or more configuration files is a type definition file that describes details of one of said plurality of TLV Elements.

13. The message engine of claim 11, wherein said one of said one or more configuration files is a layout definition file that describes the structural layout of at least some of said plurality of TLV Elements within said TLV Message in relation to at least one other one of said plurality of TLV Elements.
